(19) United States
(12) Patent Application Publication
(10) Pub. No.: US 2023/0264375 A1
(43) Pub. Date: Aug. 24, 2023

(54) DEVICE FOR TREATING BODY HAIR

(71) Applicant: SHENZHEN YUMI INFO. CO., LTD, SHENZHEN (CN)

(72) Inventor: XUELIAN ZHANG, SHENZHEN (CN)

(21) Appl. No.: 18/113,056

(22) Filed: Feb. 23, 2023

(30) Foreign Application Priority Data
Feb. 23, 2022 (CN) 202220371580.5

(51) Int. Cl. B26B 21/04; B26B 21/38; A45D 24/10

(52) U.S. Cl. CPC B26B 21/04; B26B 21/38; A45D 24/10

(57) ABSTRACT

A device for treating body hair includes a host and a functional component. The functional component is disposed on an end part of the host. The functional component includes a first functional part and a second functional part respectively at a first inner side and a second inner side. The first functional part includes a knife blade and a knife blade notch, and the knife blade extends out of the first functional part from the knife blade notch. The second functional part includes a hair combing part and a heating body, the heating body is fixedly disposed in the hair combing part. The first functional part includes the knife blade for removing body hair, and the second functional part includes the hair combing part and the heating body for combing and curling the body hair.

### TECHNICAL FIELD

The present disclosure relates to a technical field of personal care products, and in particular to a device for treating body hair.

### BACKGROUND

Hair removers are personal care products widely used at present, which are convenient for removing body hair on human skin surfaces and are favored by people who enjoy dressing up. No matter men or women may use the hair removers in daily life for removing various body hair, such as beard and leg hair, so as to have a more attractive appearance in front of other people. Most of current hair removers each only has one functional component for removing body hair, which is single in function and cannot achieve multiple purposes. When users want to beautify the body hair, a related beauty instrument needs to be additionally purchased, moreover, if the functional component for removing the body hair is accidentally damaged, a whole device of the hair removers is directly scrapped, thereby causing waste.

### SUMMARY

In order to solve above problems, the present disclosure provides a device for treating body hair.

The present disclosure provides following technical solutions.

The present disclosure provides the device for treating body hair, including a host and a functional component. The functional component is disposed on an end part of the host. The functional component includes a first functional part and a second functional part respectively at a first inner side and a second inner side. The first functional part includes a knife blade and a knife blade notch, and the knife blade extends out of the first functional part from the knife blade notch. The second functional part includes a hair combing part and a heating body, the heating body is fixedly disposed in the hair combing part.

Furthermore, a partition plate is disposed between the first functional part and the second functional part, a bobbin is disposed on the partition plate, and the bobbin is fixedly disposed in the second functional part.

Furthermore, the functional component further includes a first housing, a second housing, and a third housing. The first housing is movably disposed on a first side of the host, the second housing and the third housing are disposed on a second side of the host. The rotating shaft is fixedly disposed in the first housing, the mounting cylinder is fixedly disposed in the third housing, and the second housing is movably connected with the third housing.

Furthermore, a first clamping part is disposed on the first housing, a second clamping part is disposed on the second housing, the first clamping part is clamped with the second clamping part, so that the second housing is only capable of detaching from the first housing in a first direction.

Furthermore, the functional component further includes a pushing lock, a first lock hole and a second lock hole are respectively defined on the second housing and the third housing, the first lock hole is directly aligned with the second lock hole in a same plane; the pushing lock includes a lock head and a pushing head, and the lock head is clamped in the first lock hole and the second lock hole. The third housing includes a lock groove, the pushing head is partially accommodated in the lock groove. When the pushing head is pushed to completely separate the lock head from the second lock hole, the second housing is detached from the first hosing in the first direction.

Furthermore, the host further includes a charging hole, a first mounting hole, and a dustproof cover at one end distal from the functional component. The dustproof cover covers the charging hole, the dustproof cover includes a mounting column, and the mounting column is partially clamped and disposed in the first mounting hole.

Furthermore, the host further includes a printed circuit board (PCB, a battery, and a button. The battery is electrically connected to the PCB, and the button is movably disposed on the PCB.

Furthermore, the first functional part further includes a movable blade and a fixed blade. The device for treating body hair further includes a driving motor, a second gear, and a transmission rod. The driving motor includes a first gear, and the first gear is meshed with the second gear. A first end of the transmission rod is fixedly connected to the second gear, a second end of the transmission rod is fixedly connected to the movable blade. The first gear rotates to drive the second gear and the transmission rod to rotate and further drive the movable blade to move with respect to the fixed blade.

Furthermore, the first functional part further includes an elastic piece and a second mounting hole. The elastic piece is fixedly disposed in the first functional part, the elastic piece includes an elastic part, and the elastic part abuts against the movable blade. The fixed blade includes a mounting part, and the mounting part is clamped in the second mounting hole. First clamping blocks are fixedly disposed in the first functional part. First holes are defined on the fixed blade, second holes are defined on the movable blade, and third holes are defined on the elastic piece. The first clamping blocks penetrate through the second holes and the third holes in sequence, and are clamped with the first holes.

Furthermore, the functional component further includes a rotating shaft and a mounting cylinder respectively at a third inner side and a fourth inner side, the host includes a shaft hole, and the rotating shaft penetrates through the shaft hole and is inserted into the mounting cylinder. A positioning core is fixedly disposed in the functional component, a positioning head is disposed on a middle of the positioning core, a positioning part is disposed on an outer side of the host, and a plurality of positioning grooves are defined on the positioning part. When the functional component rotates with the rotating shaft as a rotation center, the positioning core synchronously rotates to drive the positioning part to elastically deform, so as to enable the positioning head to respectively clamp in each of the plurality of the positioning grooves.

Beneficial effects of the present disclosure are as following.

The device for treating body hair of the present disclosure is provided with the functional component including the first functional part and the second functional part on the end part. The first functional part includes the knife blade for removing body hair, and the second functional part includes the hair combing part and the heating body for combing and curling the body hair. The present disclosure combines two functional parts in one device, so that the users may use two functions by carrying only one device, which is more convenient to carry.

### BRIEF DESCRIPTION OF DRAWINGS

FIG. 1 is a three-dimensional schematic diagram of a device for treating body hair according to one embodiment of the present disclosure.

FIG. 2 is an exploded structural schematic diagram of the device for treating body hair according to one embodiment of the present disclosure.

FIG. 3 is an exploded structural schematic diagram of a functional component according to one embodiment of the present disclosure.

FIG. 4 is a structural schematic diagram of a positioning part according to one embodiment of the present disclosure.

FIG. 5 is a schematic diagram of a first clamping part and a second clamping part according to one embodiment of the present disclosure.

### DETAILED DESCRIPTION

In order to describe technical solutions of the present disclosure more clearly and completely, the present disclosure is further described below with reference to the accompanying drawings.

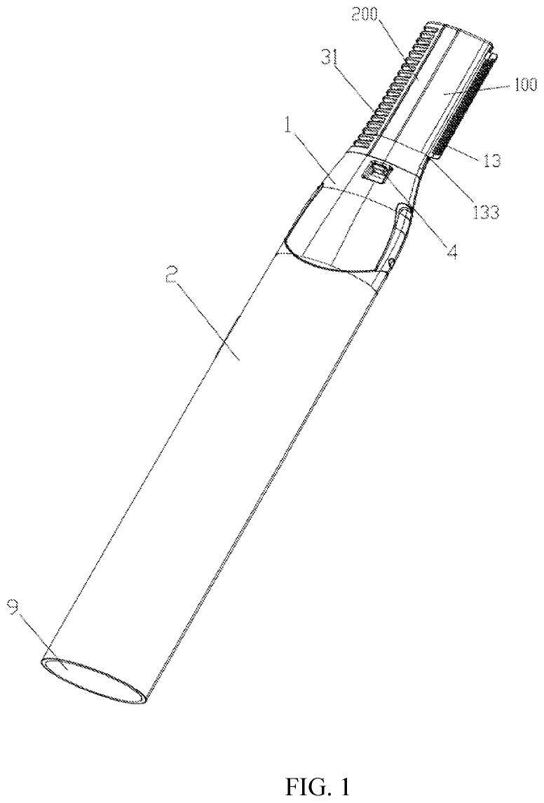

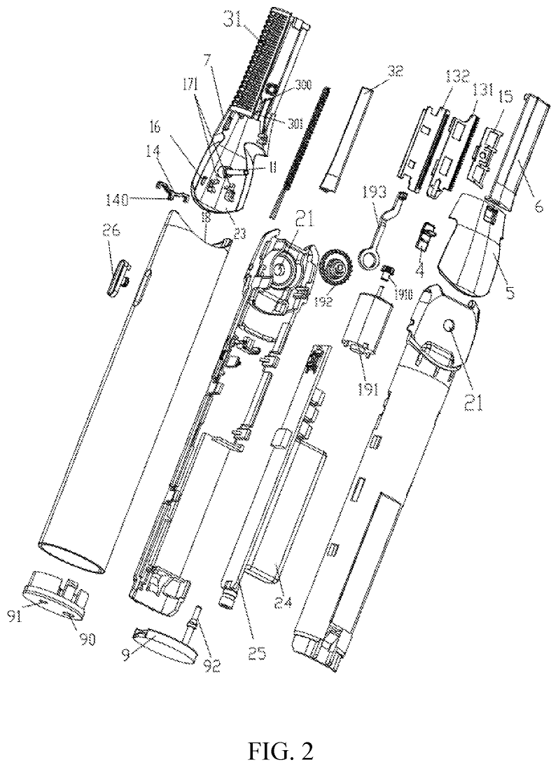

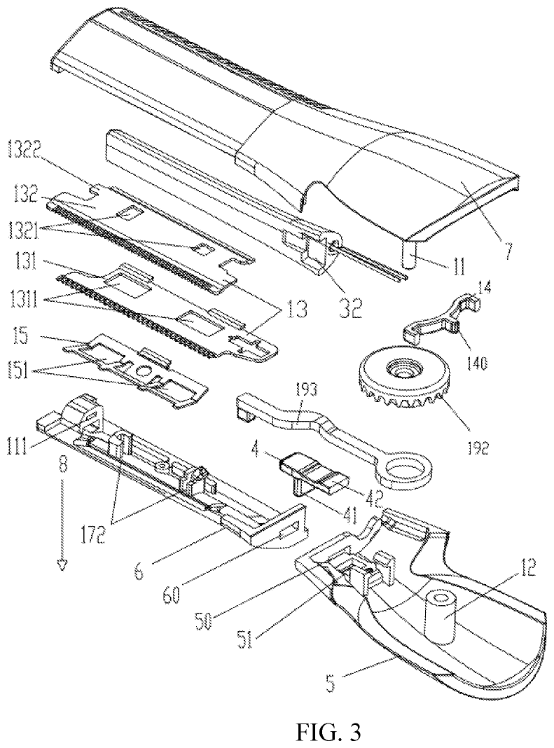

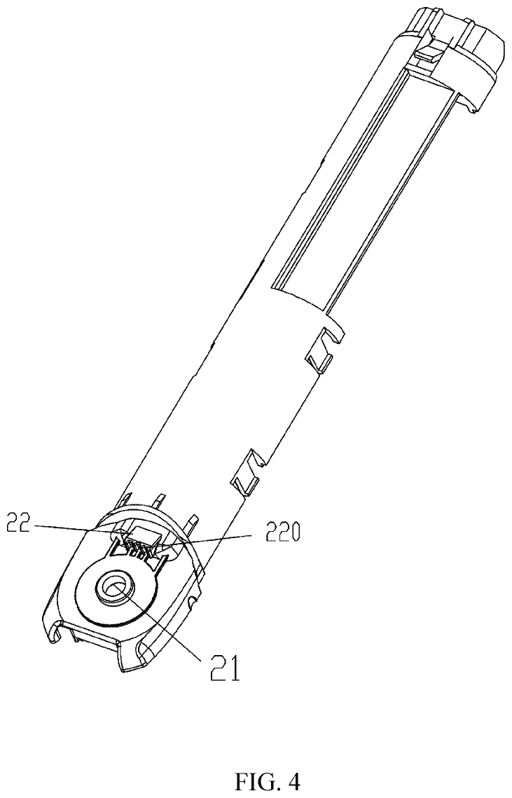

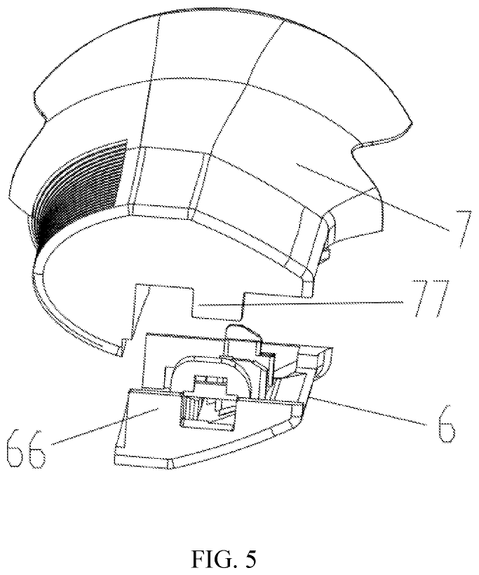

As shown in FIGS. 1-5, one embodiment of the present disclosure provides a device for treating body hair, including a host 2 and a functional component 1. The functional component 1 is disposed on an end part of the host 2, and the functional component 1 includes a first functional part 100 and a second functional part 200. The first functional part 100 includes a knife blade 13 for removing body hair, a hair combing part 31 is disposed at an end part of the second functional part 200 for combing and curling the body hair. The knife blade 13 and the hair combing part 31 are respectively located on two sides of the functional component 1. A heating body 32 is disposed in the hair combing part 31, the heating body 32 is electrically connected to a printed circuit board (PCB) 25, the PCB 25 and a battery 24 are disposed in the host 2, and a button 26 is movably disposed on the PCB 25. Users may press the button 26 to control circuits on the PCB 25. A long press on the button 26 controls the device for treating body hair to turn on or off, a short press on the button 25 switches use of the first functional part 100 and the second functional part 200. That is, the device for treating body hair is electrically operated, and when the button 26 is pressed an odd number of times after switching on, a driving device including a driving motor 191 drives the knife blade 13 to work, so as to achieve a function of hair removing; when the button 26 is pressed an even number of times, the heating body 32 is energized to heat, so as to curl and comb the body hair. The hair combing part 31 is more suitable for shorter body hair, such as eyelashes.

It should be understood that operation modes of the device for treating body hair is not limited hereto, for example, in another embodiment, the device for treating body hair may further be manually operated.

In the embodiment, the driving device includes the driving motor 191, a second gear 192, and a transmission rod 193. The driving motor 191 is electrically connected to the PCB 25, a fixed blade 132 is fixedly disposed in the first functional part 100, a first gear 1910 is disposed on a rotation shaft of the driving motor 191. The host 2 includes a circular groove, and the second gear 192 is movably disposed in the circular groove. The first gear 1910 is meshed with the second gear 192, and a rotation center line of the first gear 1910 is perpendicular to a rotation center line of the second gear 192, a first end of the transmission 193 is a circular ring, a circular truncated cone is disposed on the second gear 192, the circular ring is clamped and disposed on the circular truncated cone, the movable blade 131 includes a clamping hole, a second end of the transmission rod 193 is clamped and disposed in the clamping hole. When the button 26 is pressed to drive the driving motor 191 to operate, the first gear 1910 on the rotation shaft of the driving motor 191 drives the second gear 192 to rotate, thereby driving the transmission rod 193 to rotate, so that the movable blade 131 moves with respect to the fixed blade 132 to achieve effect of removing body hair.

In one embodiment, the first functional part 100 further includes an elastic piece 15 and a second mounting hole 61. The elastic piece 15 is fixedly disposed in the first functional part 100, and an elastic part 150 of the elastic piece 15 abuts against the movable blade 131. The second mounting hole 61 is defined on an end part, distal from the driving device, of the first functional part 100. The fixed blade 132 includes a mounting part 1322 at one end, and the mounting part 1322 is clamped and disposed in the second mounting hole 61. Meanwhile, first clamping blocks 172 penetrate through second holes 1311 and third holes 151 in sequence, and are clamped with the first holes 1321, both the second holes 1311 and the third holes 151 are larger than the first holes 1321. The elastic piece 15 plays a role in helping the fixed blade 132 to rebound in movement.

In the embodiment, the first functional part 100 includes a knife blade notch 133, the knife blade notch 133 is disposed on one side, opposite to the hair combing part 31, of the host 2, both the movable blade 131 and the fixed blade 132 include cutter teeth on the same side, and the cutter teeth extend out of the first functional part 100 through the knife blade notch 133. The users may place the body hair in proximity to the cutter teeth and then press the button 26 to drive the driving device to move the movable blade 131 with respect to the fixed blade 132 for cutting off the body hair.

In the embodiment, a rotating shaft 11 and a mounting cylinder 12 are fixedly disposed in the functional component 1, the host 2 includes a shaft hole 21, and the rotating shaft 11 penetrates through the shaft hole 21 and is inserted into the mounting cylinder 12. A circular hole is defined on a middle of the second gear 192, the rotating shaft 11 penetrates through the circular hole and the circular ring on the transmission rod 193. An arc-shaped groove 18 is defined at a first end, close to the functional component 1, of the host 2, the functional component 1 includes an arc-shaped part 23, when the functional component 1 rotates with the rotating shaft 11 as a rotation center, the arc-shaped part 23 rotates in the arc-shaped groove 18. A positioning core 14 is clamped between a plurality of clamping blocks 171, and two ends of the positioning core 14 are respectively clamped in clamping grooves 16. A positioning head 140 is disposed on a middle of the positioning core 14, a positioning part 22 is disposed on an outer part of the host 2, three positioning grooves 220 are defined on the positioning part 22. When the functional component 1 rotates with the rotating shaft 11 as the rotation center, the positioning head 140 synchronously rotates to elastically deform a part of the positioning part 22 where the positioning part 22 is in contact with the positioning head 140, so as to enable the positioning head 140 to respectively clamp in each of the three positioning grooves 220, thereby providing the functional component 1 with three usage states with respect to the host 2. The three usage states of the functional component 1 include a first state in which the functional component 1 directly faces the host 2, and second and third states in which the functional component 1 is laterally offset with respect to the host 2, and the users may select a suitable usage state of the first functional part 100 and the second functional part 200 as required.

Certainly, in another embodiment, the functional component 1 may also be set to fixedly connect to the host 2.

In the embodiment, the functional component 1 further includes a first housing 7, a second housing 6, and a third housing 5. The first housing 7 is movably disposed on a first side of the host 2, the second housing 6 and the third housing 5 are disposed on a second side of the host 2. The rotating shaft 11 is fixedly disposed in the first housing 7, the mounting cylinder 12 is fixedly disposed in the third housing 5. A first clamping part 77 is disposed on the first housing 7, a second clamping part 66 is disposed on the second housing 6, the first clamping part 77 is clamped with the second clamping part 66, so that the second housing 6 is only capable of detaching from the first housing 7 in a first direction. The second housing 6 is movably connected with the third housing 5. A pushing lock 4 is disposed between the first housing 6 and the third housing 5, the pushing lock 4 includes a pushing head 41 and a lock head 42, and the rotating part 5 includes a lock groove 51. The pushing head 41 is partially accommodated in the lock groove 51, a first lock hole 50 and a second lock hole 60 are respectively defined on the third housing 5 and the second housing part 6, the first lock hole 50 is communicated with the second lock hole 60, the lock head 42 is clamped in the first lock hole 50 and the second lock hole 60, moreover, the lock head 42 abuts against the first lock hole 50 and the second lock hole 60. When the lock head 42 is clamped in the second lock hole 60, the third housing 5 and the second housing 6 are limited by the pushing lock 4 and cannot be detached; when the pushing head 41 is pushed to completely separate the lock head 42 from the second lock hole 60, the knife blade holding part 6 is not limited by the pushing lock 4, so that the users may detach the second housing 6 to replace, repair, or clean elements, such as the knife blade, in the first functional part 100.

In the embodiment, a partition plate 300 is disposed between the first functional part 100 and the second functional part 200, a bobbin 301 is disposed on the partition plate 300, and the bobbin 301 is configured to draw up a long wire. The host 2 further includes a charging hole 91, a first mounting hole 92, and a dustproof cover 9 at one end distal from the functional component 1. The dustproof cover 9 covers the charging hole 91 to provide protection of dustproof and waterproof to the charging hole 91. The dustproof cover 9 includes a mounting column 92, and the mounting column 92 is partially clamped and disposed in the first mounting hole 90, and the users can pull out the dustproof cover 9 with a slight force to charging the device for treating body hair. A surface of the host 2, where the dustproof cover 9 is located, is a plane, which is more convenient for the user to place no matter whether the host 2 is vertically placed on a desktop or placed in slots of various dressing supplies.

Certainly, the present disclosure may further have other various embodiments, and based on this embodiment, a person of ordinary skill in the art may obtain other embodiments without making any creative effort, all of which fall within scopes of protection of the present disclosure.

What is claimed is:

1. A device for treating body hair, comprising:
a host; and
a functional component;
wherein the functional component is disposed on an end part of the host; the functional component comprises a first functional part and a second functional part respectively at a first inner side and a second inner side; the first functional part comprises a knife blade and a knife blade notch, and the knife blade extends out of the first functional part from the knife blade notch; the second functional part comprises a hair combing part and a heating body, the heating body is fixedly disposed in the hair combing part.

2. The device for treating body hair according to claim 1, wherein a partition plate is disposed between the first functional part and the second functional part, a bobbin is disposed on the partition plate, and the bobbin is fixedly disposed in the second functional part.

3. The device for treating body hair according to claim 1, wherein the functional component further comprises a rotating shaft and a mounting cylinder respectively at a third inner side and a fourth inner side, the host comprises a shaft hole, and the rotating shaft penetrates through the shaft hole and is inserted into the mounting cylinder; and the functional component rotates with the rotating shaft as a rotation center.

4. The device for treating body hair according to claim 3, wherein a positioning core is fixedly disposed in the functional component, a positioning head is disposed on a middle of the positioning core, a positioning part is disposed on an outer side of the host, a plurality of positioning grooves are defined on the positioning part; when the functional component rotates with the rotating shaft as the rotation center, the positioning core synchronously rotates to drive the positioning part to elastically deform, so as to enable the positioning head to respectively clamp in each of the plurality of the positioning grooves.

5. The device for treating body hair according to claim 4, wherein the functional component further comprises a first housing, a second housing, and a third housing; the first housing is movably disposed on a first side of the host, the second housing and the third housing are disposed on a second side of the host; the rotating shaft is fixedly disposed in the first housing, the mounting cylinder is fixedly disposed in the third housing, and the second housing is movably connected with the third housing; a first clamping part is disposed on the first housing, a second clamping part is disposed on the second housing, the first clamping part is clamped with the second clamping part, so that the second housing is only capable of detaching from the first housing in a first direction.

6. The device for treating body hair according to claim 5, wherein the functional component further comprises a pushing lock, a first lock hole and a second lock hole are respectively defined on the second housing and the third housing, the first lock hole is directly aligned with the second lock hole in a same plane; the pushing lock comprises a lock head and a pushing head, and the lock head is clamped in the first lock hole and the second lock hole; the third housing comprises a lock groove, the pushing head is partially accommodated in the lock groove; and when the pushing head is pushed to completely separate the lock head from the second lock hole, the second housing is detached from the first hosing in the first direction.

7. The device for treating body hair according to claim 1, wherein the host further comprises a charging hole, a first mounting hole, and a dustproof cover at one end distal from the functional component; the dustproof cover covers the charging hole, the dustproof cover comprises a mounting column, and the mounting column is partially clamped and disposed in the first mounting hole.

8. The device for treating body hair according to claim 1, wherein the host further comprises a printed circuit board (PCB), a battery, and a button; the battery is electrically connected to the PCB, and the button is movably disposed on the PCB.

9. The device for treating body hair according to claim 1, wherein the first functional part further comprises a movable blade and a fixed blade; the device for treating body hair further comprises a driving motor, a second gear, and a transmission rod; the driving motor comprises a first gear, and the first gear is meshed with the second gear; a first end of the transmission rod is fixedly connected to the second gear, a second end of the transmission rod is fixedly connected to the movable blade; and the first gear rotates to drive the second gear and the transmission rod to rotate and further drive the movable blade to move with respect to the fixed blade.

10. The device for treating body hair according to claim 9, wherein the first functional part further comprises an elastic piece and a second mounting hole; the elastic piece is fixedly disposed in the first functional part, the elastic piece comprises an elastic part, and the elastic part abuts against the movable blade; the fixed blade comprises a mounting part, and the mounting part is clamped in the second mounting hole; first clamping blocks are fixedly disposed in the first functional part; first holes are defined on the fixed blade, second holes are defined on the movable blade, and third holes are defined on the elastic piece; the first clamping blocks penetrate through the second holes and the third holes in sequence, and are clamped with the first holes.
